(19) United States
(12) Patent Application Publication
(10) Pub. No.: US 2003/0030364 A1
(43) Pub. Date: Feb. 13, 2003

(54) Cathode ray tube

(75) Inventor: Sung Woo Ko, Gumi (KR)

Correspondence Address: FLESHNER & KIM, LLP, P.O. Box 221200, Chantilly, VA, 20153-1200, US

(73) Assignee: LG. Philips Displays Korea Co., Ltd.

(21) Appl. No.: 10/154,918

(22) Filed: May 28, 2002

(30) Foreign Application Priority Data
Jul. 23, 2001 (KR) 44302/2001

(51) Int. Cl. H01J 31/00

(52) U.S. Cl. 313/477 R

(57) ABSTRACT

A cathode ray tube having a panel with a fluorescent film made of a fluorescent material coated at the inner surface thereof; a cathode mounted in the panel and generating an electron beam; an electron beam controller for controlling and deflecting the electron beam in order to hit the fluorescent film; and a back glass attached to the panel and sealed in a state that the cathode and the electron beam controller are mounted therein, in which a ratio of a minimum thickness of a panel glass to a minimum thickness of a skirt portion of the panel is below 1.0. The full depth of the cathode ray tube is reduced and the weight of the cathode ray tube is minimized by controlling the thickness of the panel glass, the skirt portion of the panel glass and the back glass. In addition, the atmospheric pressure applied to the panel glass and the back glass is uniformly distributed to the panel glass, the back glass and the skirt portion, thereby performing a deformation.

### BACKGROUND OF THE INVENTION

1. Field of the Invention

The present invention relates to a cathode ray tube, and more particularly, to a cathode ray tube that is capable of reducing a full length of a cathode ray tube by controlling thickness of panel glass, a skirt portion of a panel and a back glass, minimizing a weight of the cathode ray tube and buffering an atmospheric pressure.

2. Description of the Background Art

As shown in FIG. 1, a conventional flat cathode ray tube includes: a panel glass 1 having a fluorescent material coated at the inner surface; a funnel glass 5 adhered at a rear end of a panel glass 1; a shadow mask 2 mounted at an inner side of the panel glass 1 with a certain space therebetween and having a plurality of holes to pass electron beams; an electron gun 3 sealed in the neck portion of the funnel glass 5 and radiating the electron beam; and a deflection yoke 4 for deflecting the electron beams discharged from the electron gun.

The panel glass 1 obtains the minimum space so that the electron beams can accurately light a screen, and maintains a high vacuum state to prevent a collision with other particles. In order to reduce an influence of an electric field to the electron beams, black lead is coated inside the panel glass.

In the cathode ray tube constructed as described above, electrons are activated at a cathode oxide and discharged, and electrons of the fluorescent material are excited with a kinetic energy accelerated by scores of kV accelerating electrode, to emit light. In this respect, about 75˜80% of electrons is blocked by the shadow mask (2) and only the remaining reaches the screen.

At this time, as for the electrons blocked by the shadow mask 2, the kinetic energy of the electrons is mostly transformed to a thermal energy and the remaining is transformed to electromagnetic wave or the like.

The cathode ray tube that uses the electrons as an energy source and displays information on the screen by using the deflection yoke 4 requires a housing structure for obtaining a space in which electrons can move. The housing structure is made of an insulation material, can endure an atmospheric pressure, should have a little outgassing in collision with electrons, should be transparent and stable physically and chemically even at a temperature process of 370˜450° C.

Accordingly, the housing structure of the most cathode ray tube is made of glass, a material that satisfies the above indicated conditions.

However, since the conventional cathode ray tube has one place of energy source for displaying information on the screen and uses only one deflection yoke 4, it is difficult to implement a deflection sensitivity of above a certain level.

Accordingly, in order to display accurate information on the screen, comparatively large internal space is necessary, which is obtained by the panel glass 1 and the funnel glass 5.

In order to prevent deformation and damage due to the atmospheric pressure working and stress occurrence, the panel glass 1 should have a certain thickness, and the funnel glass 5 has a smooth curved form in view of obtaining a space and coping with a vacuum strength.

If the width of the portion where the funnel glass 1 and the panel glass 5 are sealed is thinner than the thickness of the panel glass 1, the thickness of the funnel glass 5 is thinner than the panel glass 1 on the whole.

In the cathode ray tube with the above described structure, even if the panel glass 1 receives a force vertically by atmospheric pressure, the force is transmitted to the funnel glass 5, and the force which has been transferred to the funnel glass 5 is distributed to the funnel glass 5 in a form of hemisphere, thereby preventing deformation of the panel glass 1.

FIGS. 4A and 4B are graphs showing a ratio of a minimum thickness of the panel glass 1 to a minimum thickness of a skirt portion of the panel glass 1, of which FIG. 4A shows a cathode ray tube having the width-to-length ratio of a screen is 4:3 and FIG. 4B shows a cathode ray tube having the width-to-length ratio of 16:9.

As shown in FIGS. 4A and 4B, in a size more than 8 inches, the ratio of the minimum thickness of the panel glass 1 to the minimum thickness of the skirt portion of the panel glass 1 is above 1.15, and this ratio is increased for a flat type cathode ray tube.

However, such a cathode ray tube has a great volume due to the curved funnel glass 5 and very complicated internal structure.

Thus, in an effort to solve the problem, instead of the funnel glass 5 as shown in FIG. 2, a back glass 6 is used to form a flat type cathode ray tube with a reduce the front length.

As shown in FIG. 3, the flat type cathode ray tube includes, a cathode 8 positioned between the panel 1 glass and the back glass 6 and generating electron beams, an electrode 9 for emitting an electron beam at the entire surface of the cathode 8, a control electrode 10 for controlling the electron beam; two electrodes 11 and 12 for focussing the electron beam, a horizontal deflection electrode 13 and a vertical deflection electrode 15 for deflecting the electron beam.

Reference numeral 7 denotes a back electrode and 14 denotes a G_{shield}.

The flat type cathode ray tube adopts a deflection method of a passive driving method, of which the panel glass 1, the back glass 6 and the skirt portion 1a have the same thickness.

In this respect, however, the skirt portion la makes a working point of every force applied to the atmospheric pressure, and in case of the cathode ray tube having the short depth, there is a limitation that the skirt portion 1a distributes a force, resulting in that the skirt portion 1a is deformed partially and seriously, and in a worse case, the skirt portion la is damaged.

### SUMMARY OF THE INVENTION

Therefore, an object of the present invention is to provide a cathode ray tube that is capable of reducing a full depth of a cathode ray tube by controlling thickness of panel glass, a skirt portion of a panel and a back glass, minimizing a weight of the cathode ray tube and buffering an atmospheric pressure.

To achieve these and other advantages and in accordance with the purpose of the present invention, as embodied and broadly described herein, there is provided a cathode ray tube having a panel with a fluorescent film made of a fluorescent material coated at the inner surface thereof; a cathode mounted in the panel and generating an electron beam; an electron beam controller for controlling and deflecting the electron beam in order to hit the fluorescent film; and a back glass attached to the panel and sealed in a state that the cathode and the electron beam controller are mounted therein, in which a ratio of a minimum thickness of a panel glass to a minimum thickness of a skirt portion of the panel is below 1.0, a ratio of a minimum thickness of the back glass to a minimum thickness of the skirt portion of the panel is below 1.0, and the thickness of the skirt portion of the panel, the thickness of the panel glass, and the thickness of the back glass satisfy the following equation (1):

$$0.7 \leq \frac{\begin{matrix}\text{thickness of panel glass} \times \\ \text{thickness of back glass}\end{matrix}}{{\text{Minium thickness of skirt portion}}^{2}} \leq 1.1 \qquad ( 1 )$$

The cathode ray tube of the present invention has a full depth of below 200 mm and a diagonal length of the panel of above 8 inches.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing the structure of a cathode ray tube in accordance with a conventional art;

FIG. 2 is a view showing a panel glass and a back glass of a flat type cathode ray tube in accordance with the conventional art;

FIG. 3 is a view showing an internal structure of the flat type cathode ray tube in accordance with the conventional art;

FIG. 4A is a graph showing a ratio of a minimum thickness of a panel glass to a minimum thickness of a skirt portion according to a screen size;

FIG. 4B is a graph showing a ratio of a minimum thickness of a panel glass to a minimum thickness of a skirt portion according to a screen size;

FIG. 5A shows a stress concentration distribution variation to a thickness change of the panel glass;

FIG. 5B shows a stress concentration distribution variation to a thickness change of the back glass;

FIG. 5C shows a stress concentration distribution variation to a thickness change of a skirt portion;

FIG. 6 is a graph showing a stress distribution for a ratio of multiplication of the minimum thickness of the panel glass and the minimum thickness of the back glass to a square of the minimum thickness of the skirt portion; and

FIG. 7 is a graph showing a relation among a ratio of multiplication of the minimum thickness of the panel glass and the minimum thickness of the back glass to a square of the minimum thickness of the skirt portion, a stress and a volume.

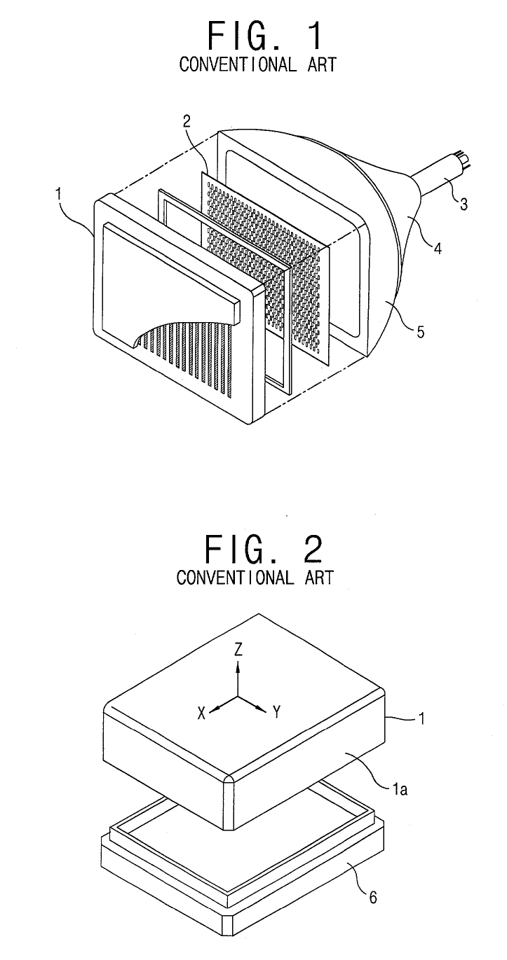

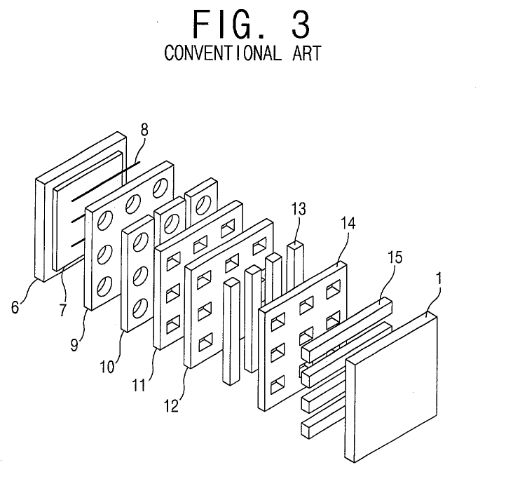

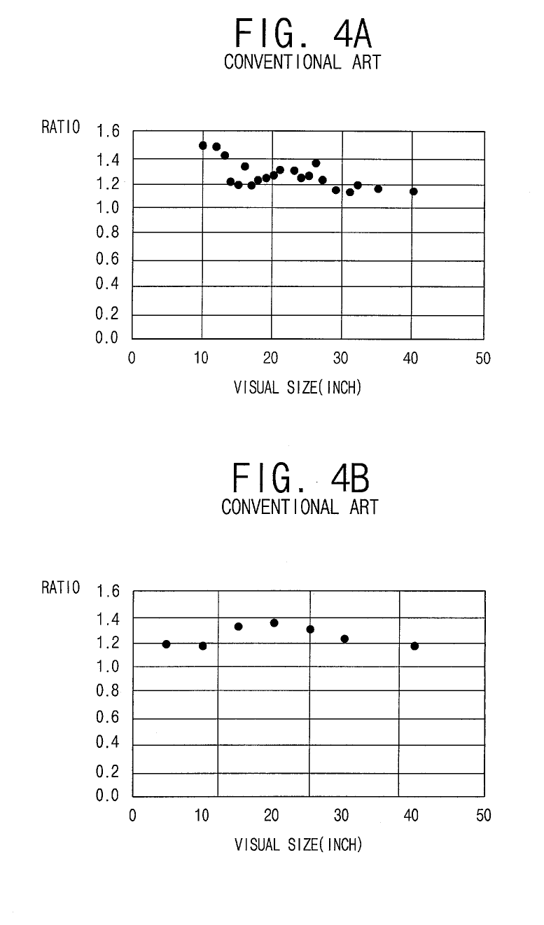

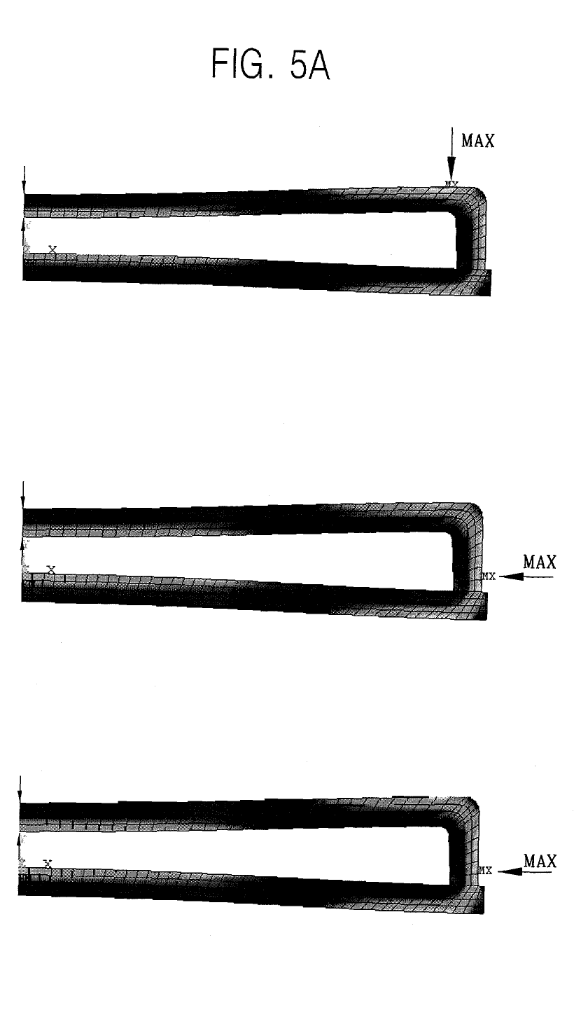

### DETAILED DESCRIPTION OF THE PREFERRED EMBODIMENTS

Reference will now be made in detail to the preferred embodiments of the present invention, examples of which are illustrated in the accompanying drawings.

The same reference numerals as in the conventional art are given to those elements that are the same as those of the conventional art, of which descriptions are omitted.

The cathode ray tube of the present invention has a housing structure with a reduced full depth, in which a panel glass 1 forming a screen with a fluorescent material coated therein is positioned at the forefront, and various parts for controlling an electron beam and a cathode 8 for generating the electron beam are positioned.

A back glass 6 supporting every device is positioned at the rearmost portion, and a skirt portion 1a is positioned between the panel glass 1 and the back glass 6 to connect them.

The panel glass 1, the back glass 6 and the skirt portion 1a are all made of glass. A minimum thickness of the skirt portion 1a is thicker than a minimum thickness of the panel glass and a minimum thickness of the back glass.

In the cathode ray tube having the short full depth, a stress due to the atmospheric pressure applied on the outer surface of the panel glass 1 and the back glass 6 is concentrated to the skirt portion 1a that connects the panel glass 1 and the back glass 6.

The stress concentrating portion is varied depending on the thickness of the panel glass 1 and the back glass 6.

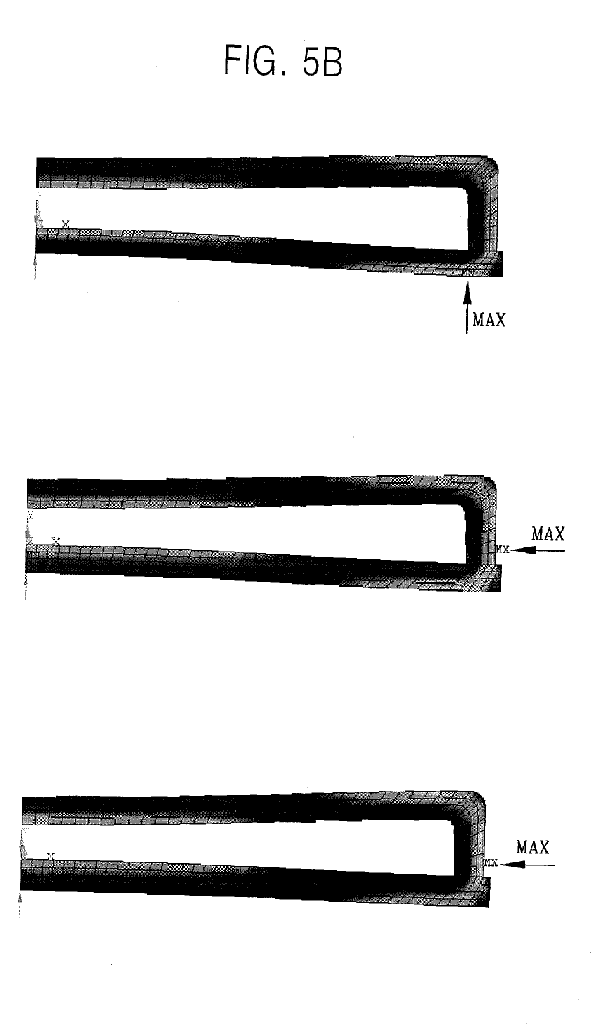

As shown in FIG. 5A, if the thickness of the panel glass 1 is thin, a stress is concentrated to the panel glass 1 adjacent to the skirt portion 1a, and thus, a great deformation occurs at the portion. In this case, if the thickness of the panel glass 1 is thick, the stress concentration is moved to the skirt portion la.

As shown in FIG. 5B, if the thickness of the back glass is thin, a stress is concentrated to a portion where the skirt portion la and the back glass 6 meets, and thus, the portion is deformed.

At this time, if the thickness of the back glass 6 becomes thick, the stress concentration is moved to the skirt portion 1a.

Meanwhile, as shown in FIG. 5C, if the thickness of the skirt portion la is thin, a stress is concentrated to the skirt portion 1a. If the thickness of the skirt portion la is thick, the stress concentration is moved to the panel glass 1 or the back glass 6.

The thickness of the skirt portion 1a varies depending on the size of the cathode ray tube and the full depth. On the whole, if the thickness of the skirt portion 1a is greater than the thickness of the panel 1 glass and the thickness of the back glass 6, the stress concentration can be reduced while reducing the mass of the device.

Accordingly, the cathode ray tube of the present invention is designed to satisfy the following equation (2):

$$\begin{matrix}\frac{\text{Minium thickness of panel glass}}{\text{Minimum thickness of skirt portion}} \leq 1.0 & ( 2 ) \\ \frac{\text{Minium thickness of back glass}}{\text{Minimum thickness of skirt portion}} \leq 1.0 & ( 2 )\end{matrix}$$

For example, a design specification result of a 20 V cathode ray tube having a short full depth shows that when the thickness of the panel glass 1 is 15 mm, the thickness of the back glass 6 is 16.5 mm and the thickness of the skirt portion 1a is 18 mm, the cathode ray tube is designed to have a light weight and small stress deformation.

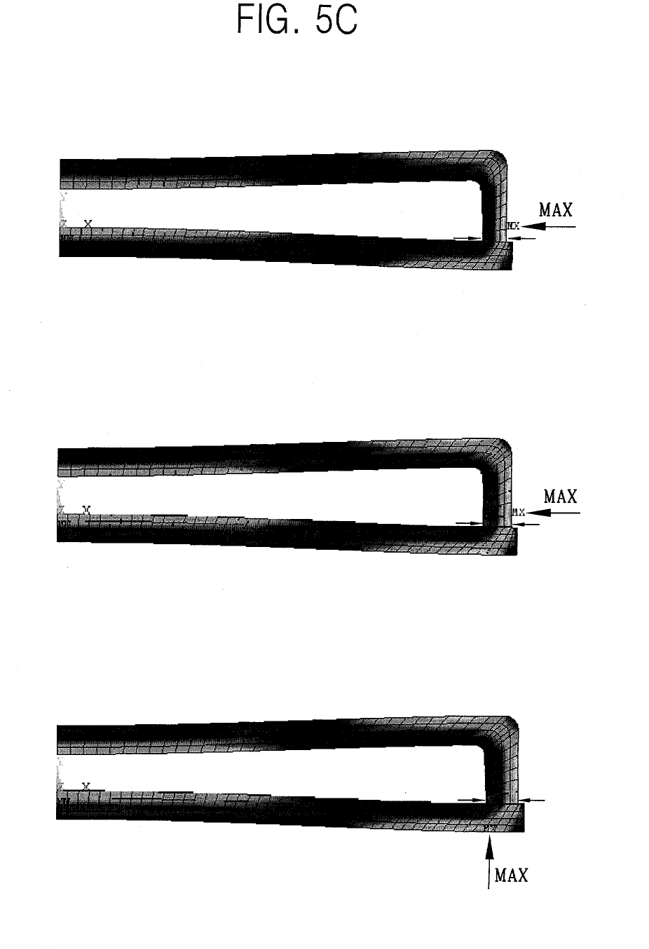

FIG. 6 is a graph showing a stress distribution for a ratio of multiplication of the minimum thickness of the panel glass and the minimum thickness of the back glass to a square of the minimum thickness of the skirt portion.

The first group has a skirt portion with a thickness of 13 mm, the second group has a skirt portion with a thickness of 15 mm, and the third group has a skirt portion with a thickness of mixture of 17 mm and 19 mm.

As noted in the graph, as the ratio of the multiplication of the minimum thickness of the panel glass 1 and the minimum thickness of the back glass 6 to the square of the minimum thickness of the skirt portion la becomes great, the volume becomes large compared to an applied stress.

Accordingly, assuming that an optimum critical stress value of a cathode ray tube is 12 Mpa, the following equation (3) can be obtained by considering the third group satisfying a practical specification of FIG. 6.

0.7≦ζ≦1.1 (3)

In the above formula, ζ is (minimum thickness of panel glass x minimum thickness of back glass)/minimum thickness of skirt portion².

If the thickness of the panel glass 1 is 15 mm, the thickness of the back glass 6 is 16.5 mm, and the thickness of the skirt portion 1a is 18 mm, a ratio of the multiplication of the minimum thickness of the panel glass 1 and the minimum thickness of the back glass 6 to the square of the minimum thickness of the skirt portion 1a is 0.764, which satisfies the above condition.

As noted in FIG. 6, the above formula is not always satisfied in every specification, and the formula is a relation formula satisfying the optimum design value in consideration of a mass and a stress for the thickness of the skirt portion 1a that satisfies a practical state to cope with the stress.

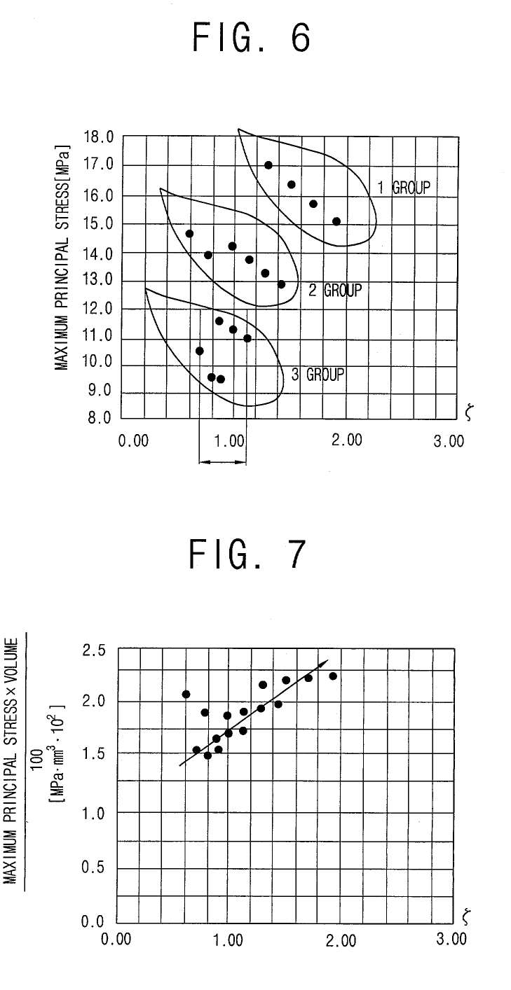

FIG. 7 is a graph showing conditions of the stress and volume that ζ satisfies a preferable range.

In FIG. 7, a horizontal axis is ζ and a vertical axis is a value obtained by multiplying a maximum main stress applied to the glass by volume and dividing the multiplying result by 100.

As shown in FIG. 7, in order for ζ to satisfy the preferable range, that is, 0.7≦ζ≦1.1, the stress applied to the glass and the volume should be all small.

Therefore, in case of the structure that the ratio of the minimum thickness of the panel 1 glass to the minimum thickness of the skirt portion 1a is below 1, an effective housing structure can be provided satisfying the range of 0.7≦ζ≦1.1 while reducing the stress and the volume.

As so far described, the cathode ray tube of the present invention has the following advantages.

That is, the full length of the cathode ray tube is reduced and the weight of the cathode ray tube is minimized by controlling the thickness of the panel glass 1, the skirt portion 1 a of the panel and the back glass 6.

In addition, the atmospheric pressure applied to the panel glass 1 and the back glass 6 is uniformly distributed to the panel glass 1, the back glass 6 and the skirt portion 1a, thereby performing a deformation.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A cathode ray tube having a panel with a fluorescent film made of a fluorescent material coated at the inner surface thereof; a cathode mounted in the panel and generating an electron beam; an electron beam controller for controlling and deflecting the electron beam in order to hit the fluorescent film; and a back glass attached to the panel and sealed in a state that the cathode and the electron beam controller are mounted therein,
wherein a ratio of a minimum thickness of a panel glass to a minimum thickness of a skirt portion of the panel is below 1.0.

2. The cathode ray tube of claim 1, wherein the controller comprises:
a control electrode for controlling the electron beam, a focussing electrode for focussing the electron beam, and a horizontal and vertical deflection electrodes for deflecting the electron beam.

3. The cathode ray tube of claim 1 has a full depth of below 200 mm.

4. The cathode ray tube of claim 1, wherein the diagonal length of the panel is above 8 inches.

5. A cathode ray tube having a panel with a fluorescent film made of a fluorescent material coated at the inner surface thereof; a cathode mounted in the panel and generating an electron beam; an electron beam controller for controlling and deflecting the electron beam in order to hit the fluorescent film; and a back glass attached to the panel and sealed in a state that the cathode and the electron beam controller are mounted therein,
wherein a ratio of a minimum thickness of the back glass to a minimum thickness of the skirt portion of the panel is below 1.0.

6. The cathode ray tube of claim 5, wherein the controller comprises: a control electrode for controlling the electron beam, a focussing electrode for focussing the electron beam, and a horizontal and vertical deflection electrodes for deflecting the electron beam.

7. The cathode ray tube of claim 5 has a full depth of below 200 mm.

8. The cathode ray tube of claim 5, wherein the diagonal length of the panel is above 8 inches.

9. A cathode ray tube having a panel with a fluorescent film made of a fluorescent material coated at the inner surface thereof; a cathode mounted in the panel and generating an electron beam; an electron beam controller for controlling and deflecting the electron beam in order to hit the fluorescent film; and
a back glass attached to the panel and sealed in a state that the cathode and the electron beam controller are mounted therein,
wherein the thickness of the skirt portion of the panel, the thickness of the panel glass, and the thickness of the back glass satisfy the following equation:
$$\frac{\begin{matrix}\text{thickness of panel glass} \times \\ \text{thickness of back glass}\end{matrix}}{{\text{Minium thickness of skirt portion}}^{2}} \leq 1.1$$

10. The cathode ray tube of claim 9, wherein the controller comprises:
a control electrode for controlling the electron beam, a focussing electrode for focussing the electron beam, and a horizontal and vertical deflection electrodes for deflecting the electron beam.

11. The cathode ray tube of claim 9 has a full depth of below 200 mm.

12. The cathode ray tube of claim 9, wherein the diagonal length of the panel is above 8 inches.

13. The cathode ray tube of claim 9, wherein the thickness of the skirt portion of the panel, the thickness of the panel glass, and the thickness of the back glass satisfy the following equation:
$$0.7 \leq \frac{\begin{matrix}\text{thickness of panel glass} \times \\ \text{thickness of back glass}\end{matrix}}{{\text{Minium thickness of skirt portion}}^{2}} \leq 1.1$$
